(19) United States
(12) Patent Application Publication
(10) Pub. No.: US 2006/0074889 A1
(43) Pub. Date: Apr. 6, 2006

(54) Method and system for identifying a complete response to a request

(76) Inventors: Keith Andrews, Winchester (GB); Andrew Ian Hickson, West Wellow (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/240,857

(22) Filed: Sep. 30, 2005

(30) Foreign Application Priority Data
Oct. 5, 2004 (GB) 0422007.5

(51) Int. Cl. G06F 17/30

(52) U.S. Cl. 707/3

(57) ABSTRACT

A method for identifying a complete response to a first request from a requesting entity, the method comprising the steps of: the requesting entity sending the first request to a first receiving entity; the first receiving entity sending a second request to a second receiving entity, the second request including a unique request identifier; the first receiving entity sending the unique request identifier to the requesting entity; and the second receiving entity sending a response to the requesting entity, the response including the unique request identifier.

### FIELD OF THE INVENTION

The present invention relates to identifying a complete response to a request. In particular, the present invention relates to identifying a complete response to a request sent to an entity in a network of cooperating hardware or software entities.

### BACKGROUND OF THE INVENTION

It is increasingly common for computer systems or software components within computer systems to draw upon the resources of other computer systems or software components in order to complete a required task. For example, a first computer system (the requester) can request services from a second computer system (the recipient of the request). The services can take the form of information to be provided by the recipient, processing to be undertaken by the recipient, or some other provision of service for the requester. The recipient will fulfil the requirements of the request and provide a response to the requester. In this way computer systems and software components can cooperate to complete the task. Such cooperation allows individual computer systems or software components to take responsibility for certain aspects of completing the task.

This approach can be developed further so that many computer systems or software components cooperate to complete a task. FIG. 1a is an exemplary arrangement of a network of cooperating software or hardware entities for responding to a request from a requester. Requester 100 is a computer system or software component which sends a first request 106 for services to a first entity 102. For example, the first entity 102 is a second computer system or software component. In fulfilling the first request 106 the first entity 102 generates a second request 108 for services to a second entity 104. The second entity 104 is thus the recipient of the second request 108 and fulfils the second request 108. The second entity 104 subsequently provides a response 110 directly to the requester 100. Thus a complete response to the first request can be generated with the cooperation of multiple entities. In a conceivable extension of FIG. 1a the second entity 104 sends further requests to further entities to fulfil the second request 108, each such request requiring a response to the requester 100.

Such cooperation between potentially many entities to fulfil a request can generate a number of individual responses to a number of individual requests. The combination of all responses constitutes a complete response to a request from a requester and it is therefore necessary to determine when all responses have been received. In the arrangement of FIG. 1a each entity can generate further requests to other entities. Consequently, the requester 100 is not able to determine how many responses it will receive. Further, the requester 100 is not able to determine how many and which entities will provide responses. Thus the requester 100 cannot determine when all responses to the first request 106 have been received.

One arrangement of entities which addresses these problems is illustrated in FIG. 1b. Requester 120 is a computer system or software component which sends a first request 126 for services to a first entity 122. In fulfilling the first request 126 the first entity 122 generates a second request 128 for services to a second entity 124. The second entity 124 is thus the recipient of the second request 128 and fulfils the second request 128. The second entity 124 subsequently provides a response 130 back to the first entity 122. The first entity 122 keeps track of all requests generated by the first entity 122 and thus can identify when complete responses are received to all such requests. First entity 122 is therefore coordinating the second request 128 and awaits for the response 130. Once the response 130 from the second entity 124 is received by the first entity 122, the first entity 122 sends a complete response 132 to the requester 120. This approach has the significant drawback that the first entity 122 is required to await and coordinate responses from the second entity 124. This involves the consumption of extra resources (such as processor time and/or storage) and extra coordination functionality at the first entity 122.

Further, in a conceivable extension of FIG. 1b the second entity 124 sends further requests to further entities to fulfil the second request 128. The second entity 124 also awaits and coordinates responses from the further entities to which requests are sent. Thus each entity is responsible for coordinating the requests it generates and for identifying a complete response to such requests before responding to its respective requester. Consequently, all entities which generate further requests will consume extra resources in awaiting and coordinating responses to such requests.

It would therefore be desirable to provide a way for a requester to determine when all responses are received for a request sent to an entity in a network of entities.

### SUMMARY OF THE INVENTION

The present invention accordingly provides, in a first aspect, a method for identifying a complete response to a first request from a requesting entity, the method comprising the steps of: the requesting entity sending the first request to a first receiving entity; the first receiving entity sending a second request to a second receiving entity, the second request including a unique request identifier; the first receiving entity sending the unique request identifier to the requesting entity; and the second receiving entity sending a response to the requesting entity, the response including the unique request identifier. Thus the requesting entity is provided with a unique request identifier of the second request by the first entity. The requesting entity is therefore able to determine that a complete response to the first request is received when the response to the second request is received with the corresponding unique request identifier.

The present invention accordingly provides, in a second aspect, a system for identifying a complete response to a first request from a requesting entity, the system comprising: means for the requesting entity to send the first request to a first receiving entity; means for the first receiving entity to send a second request to a second receiving entity, the second request including a unique request identifier; means for the first receiving entity to send the unique request identifier to the requesting entity; and means for the second receiving entity to send a response to the requesting entity, the response including the unique request identifier.

The present invention accordingly provides, in a third aspect, a computer program product comprising computer program code stored on a computer readable storage medium which, when executed on a data processing system, instructs the data processing system to carry out the method described above.

### BRIEF DESCRIPTION OF THE DRAWINGS

A preferred embodiment of the present invention will now be described, by way of example only, with reference to the accompanying drawings, in which:

FIG. 1a is an exemplary arrangement of a network of cooperating software or hardware entities for responding to a request from a requester in the prior art;

FIG. 1b is an alternative exemplary arrangement of a network of cooperating software or hardware entities for responding to a request from a requester in the prior art;

FIG. 2 is a block diagram of a computer system suitable for the operation of embodiments of the present invention;

FIG. 3 is an exemplary arrangement of a network of cooperating software or hardware entities for responding to a request from a requester in accordance with a preferred embodiment of the present invention;

FIG. 4a is a flowchart illustrating a method of the first entity of FIG. 3 in accordance with a preferred embodiment of the present invention;

FIG. 4b is a flowchart illustrating a method of the second entity of FIG. 3 in accordance with a preferred embodiment of the present invention;

FIG. 5 is a flow diagram illustrating methods of, and data flows between, the requester, the first entity and the second entity of FIG. 3 in a preferred embodiment of the present invention;

FIG. 6a is a block diagram illustrating a structure of a message from the response set of FIG. 3 in accordance with a preferred embodiment of the present invention;

FIG. 6b is a block diagram illustrating the response set of FIG. 3 including multiple messages structured according to FIG. 6a in accordance with a preferred embodiment of the present invention. Response messages to constitute the complete response set;

FIG. 7 is a further exemplary arrangement of a network of cooperating software or hardware entities for responding to a request from a requester in accordance with a preferred embodiment of the present invention; and

FIG. 8 is a flow diagram illustrating methods of, and data flows between, the requester, the first entity, the second entity and the third entity of FIG. 7 in a preferred embodiment of the present invention.

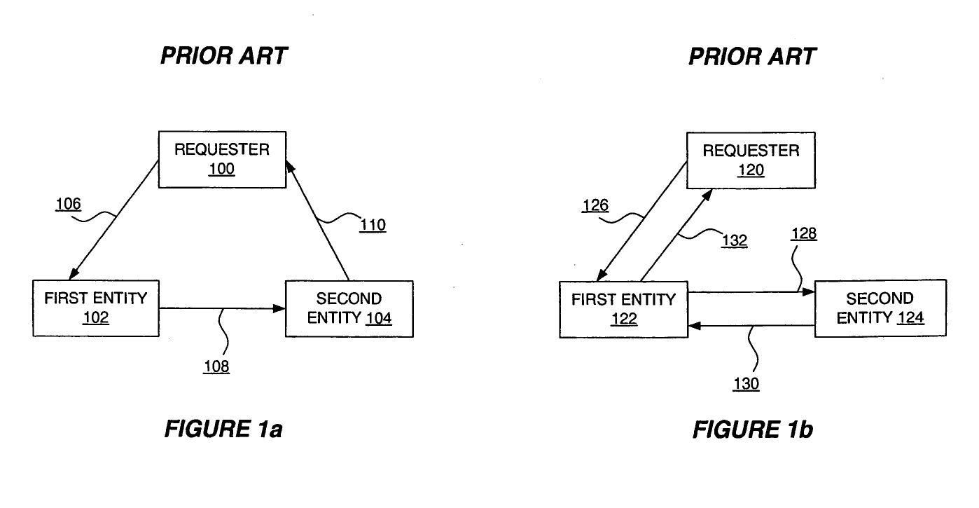

### DETAILED DESCRIPTION OF THE PREFERRED EMBODIMENT

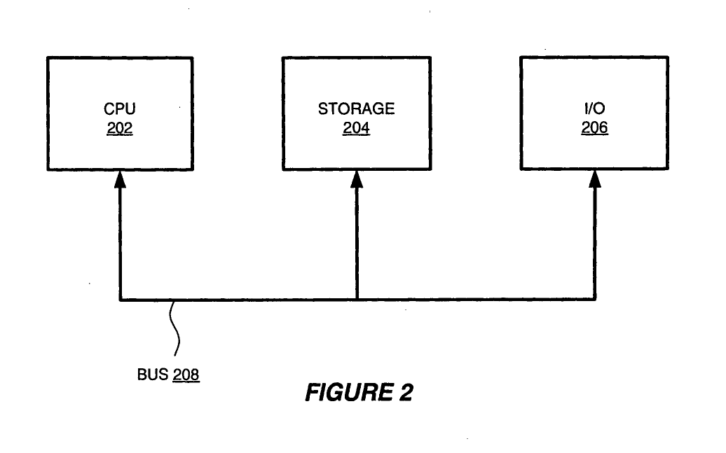

FIG. 2 is a block diagram of a computer system suitable for the operation of embodiments of the present invention. A central processor unit (CPU) 202 is communicatively connected to a storage 204 and an input/output (I/O) interface 2066 via a data bus 208. The storage 204 can be any read/write storage device such as a random access memory (RAM) or a non-volatile storage device. An example of a non-volatile storage device includes a disk or tape storage device. The I/O interface 206 is an interface to devices for the input or output of data, or for both input and output of data. Examples of I/O devices connectable to I/O interface 206 include a keyboard, a mouse, a display (such as a monitor) and a network connection.

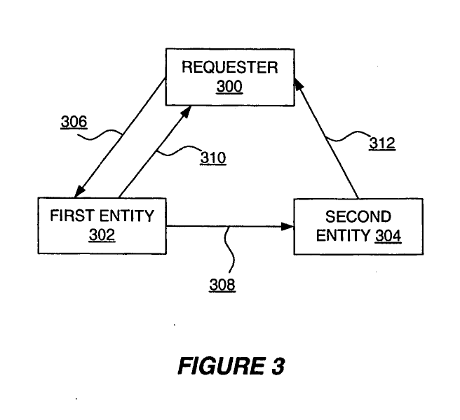

FIG. 3 is an exemplary arrangement of a network of cooperating software or hardware entities for responding to a request from a requester in accordance with a preferred embodiment of the present invention. Requester 300, first entity 302 and second entity 304 are computer systems or software components. For example, the requester 300, first entity 302 and second entity 304 are computer systems of the type illustrated in FIG. 2. Alternatively, requester 300, first entity 302 and second entity 304 are software components residing the storage 204 of a computer system of the type illustrated in FIG. 2. The requester 300, first entity 302 and second entity 304 are communicatively connected to each other. For example, the requester 300, first entity 302 and second entity 304 are provided on a computer network. The requester 300 sends a first request 306 for services to a first entity 302. The services requested by the requester 300 can include: a request for information to be provided to the requester 300; a request for processing to be undertaken by one or more entities in the network of entities; a request for a change to the configuration of one or more entities in the network of entities; a request for the storage of information at one or more entities in the network of entities; or some other provision of services for the requester such as are well known in the art.

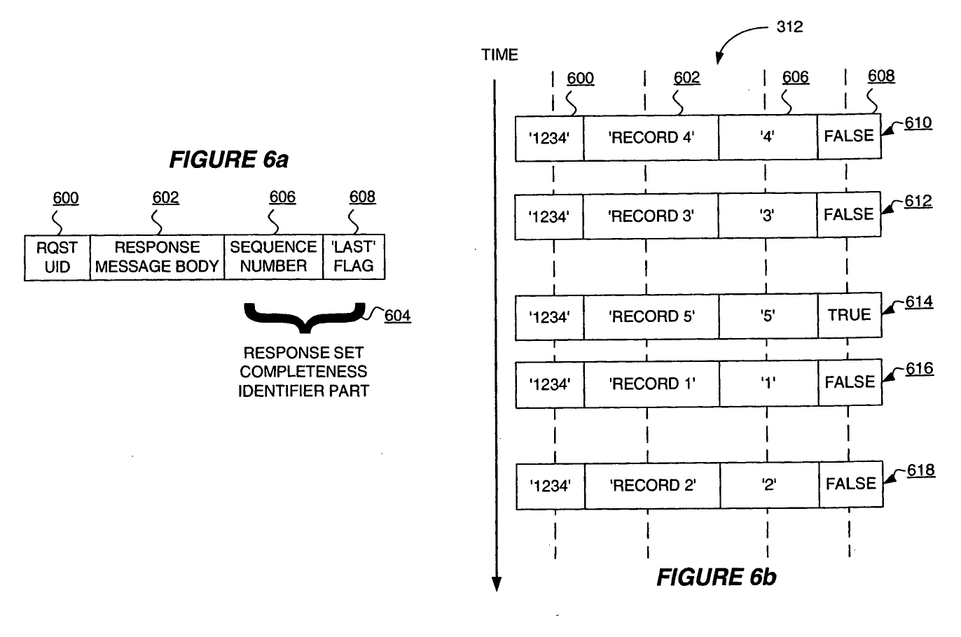

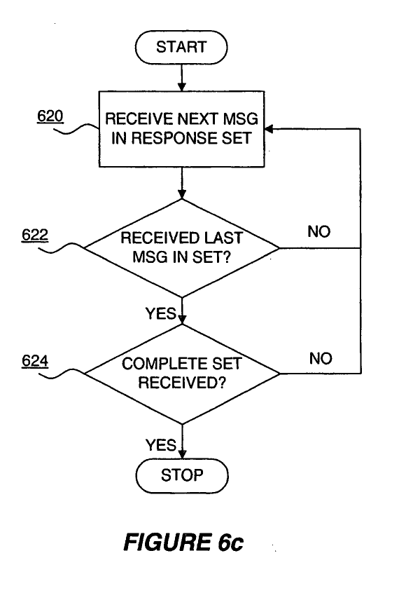

The first entity 302 fulfils the first request 306 by generating a second request 308 for services to a second entity 304. The second request 308 includes a unique identifier (UID) and a reference to the requester 300. The UID is generated by the first entity 302. Alternatively, the UID is generated by a separate entity, such as a dedicate UID generator entity (not illustrated). The UID uniquely identifies the second request 308. In an alternative embodiment, the UID further identifies the second entity 304 to which the second request 308 is sent. The reference to the requester 300 which is also included in the second request 308 is an identifier of the requester 300 which can be used to send a message to the requester 300. For example, the reference to the requester 300 can be a network address of the requester 300. The UID of the second request 308 is communicated to the requester by way of a message 310 from the first entity 302 to the requester 300. The second entity 304 receives the second request 308 for services including the UID and reference to the requester 300. The second entity 304 fulfils the second request 308 by providing the requested services. Subsequently, the second entity 304 provides a response set 312 including the UID of the second request 308. A response set is a set of one or more response messages collectively representing a single response to a single request. Response sets are considered in detail below with respect to FIGS. 6a-6c. The response set 312 is sent directly to the requester 300 using the reference to the requester 300.

Thus the requester 300 is provided with the UID of the second request 308 by the first entity 302. The requester 300 is therefore able to determine that a complete response to the first request 306 is received when the response set 312 to the second request 308 is received with the corresponding UID. In an alternative embodiment, the UID further identifies the second entity 304 to which the second request 308 is sent. Thus, in this alternative embodiment, the requester 300 is also aware that the response set 312 to the second request 308 will be received from the second entity 304. In these ways, the requester 300 is provided with information regarding the number and origin of responses which constitute a complete response to the first request 306.

In a further alternative embodiment and an extension to the arrangement of FIG. 3, the first entity 302 also provides a response set to the requester 300 corresponding to a partial response to the first request 306. Such a response set sent by the first entity 302 when combined with the response set 312 constitutes a complete response to the first request 306.

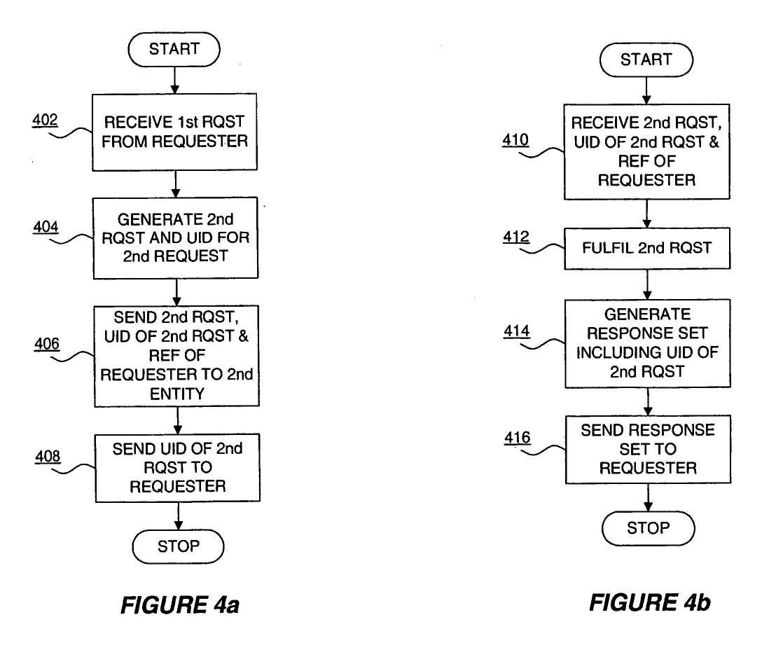

FIG. 4a is a flowchart illustrating a method of the first entity 302 of FIG. 3 in accordance with a preferred embodiment of the present invention. At step 402 the first entity 302 receives the first request 306 from the requester 300. At step 404 the first entity 302 generates the second request 308 including a UID for the second request 308. At step 406 the second request 308, including the UID for the second request 308 and the reference to the requester 300 are sent to the second entity 304. At step 408 the UID of the second request 308 is sent to the requester 300. In an alternative embodiment and an extension to the method of FIG. 4a, the first entity 302 also provides a response set to the requester 300 corresponding to a partial response to the first request 306. For example, the first entity 302 may be able to provide part of the services requested in the first request 306, such as obtaining information to be provided to the requester 300; undertaking processing for the requester 300; changing to a configuration of the first entity 304; storing information at the first entity 304; or some other service for the requester 300 such as are well known in the art.

FIG. 4b is a flowchart illustrating a method of the second entity 304 of FIG. 3 in accordance with a preferred embodiment of the present invention. At step 410 the second entity 304 receives the second request 308, including the UID for the second request 308 and the reference to the requester 300. At step 412 the second entity 304 fulfils the second request 308. For example, the second entity provides the services requested in the second request 308 such as: obtaining information to be provided to the requester 300; undertaking processing for the requester 300; changing to a configuration of the second entity 304; storing information at the second entity 304; or some other service for the requester 300 such as are well known in the art. At step 414 the second entity 304 generates the response set 312 including the UID of the second request 308. An exemplary form and content of a response set is considered in detail below with respect to FIGS. 6a-6c. Finally, at step 416 the response set 312 is sent to the requester 300.

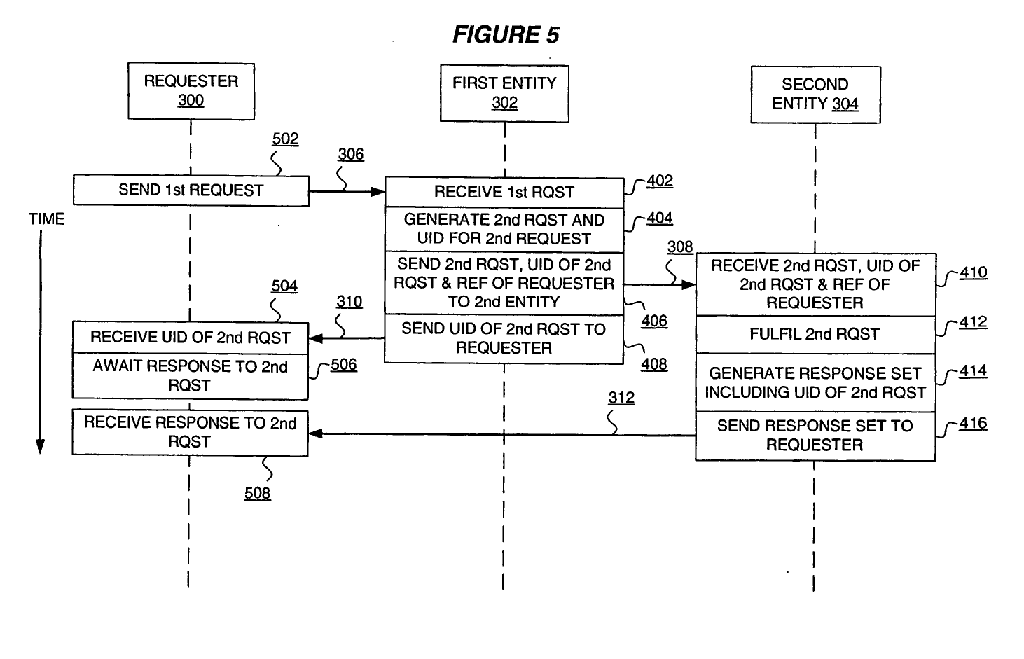

FIG. 5 is a flow diagram illustrating methods of, and data flows between, the requester 300, the first entity 302 and the second entity 304 of FIG. 3 in a preferred embodiment of the present invention. The flow diagram of FIG. 5 includes methods of the requester 300, first entity 302 and second entity 304 with the direction of flow of each method generally indicated by a bold time line, and interactions between each of the methods indicated by bold data flow lines (such as 306, 308 etc). At step 502, the requester 300 sends a first request 306 to the first entity 302. The method of the first entity 302 including steps 402 to 408 is identical to that described with respect to FIG. 4a and this will not be repeated here except to highlight the second request 308 sent to the second entity 304. The first entity 302 further sends the UID of the second request 308 to the requester in message 310. On receipt of the second request 308, the method of the second entity 304 including steps 410 to 416 is identical to that described with respect to FIG. 4b and this will not be repeated here. Attention is drawn to the response set 312 sent by the second entity 304 to the requester 300 including the UID of the second request 308. At step 504, the requester 300 receives the UID of the second request and awaits the response set 312 to the second request at step 506. Finally, at step 508 the requester 300 receives the response set 312 to the second request 308 so concluding the response to the first request 306.

FIG. 6a is a block diagram illustrating a structure of a message from the response set 312 of FIG. 3 in accordance with a preferred embodiment of the present invention. The response set 312 is a set of one or more messages which collectively constitute a complete response to the second request 308. The messages are sent by the second entity 304 and received by the requester 300 in an arbitrary order. The structure of each message illustrated in FIG. 6a is designed to allow this arbitrary nature of the messages in the response set 312. Each message in the response set 312 includes the UID 600 of the request to which the response set 312 is a response. For example, in the arrangement of FIG. 3, messages in the response set 312 include the UID of the second request 308. Each message further includes a message body 602. The message body 602 is the substantive part of the response intended to provide the content of the response to the request. For example, if the second request 308 includes a request for information, the information is provided in the message body 602 of each message in the response set 312. Each message further includes a response set completeness identifier part 604 which is arranged to allow identification of a complete response set 312. A particular example of the response set completeness identifier part 604 of each message is also illustrated including a sequence number 606 and a ‘LAST’ flag 608. The sequence number 606 is a unique number for each message in the response set 312. The messages are numbered consecutively in sequence with only a final message in the response set 312 having a TRUE value in the ‘LAST’ flag 608. In this way, the requester 300 is able to identify the complete response set 312 by extracting the sequence number 606 for each received response message and locating the final response message in the set by way of the ‘LAST’ flag 608. Thus response messages can be sent and/or received in any arbitrary order without affecting the ability of the requester 300 to determine when a complete response set 312 is received.

FIG. 6b is a block diagram illustrating the response set 312 of FIG. 3 including multiple messages structured according to FIG. 6a in accordance with a preferred embodiment of the present invention. Response messages 610 to 618 constitute the complete response set 312. Each of the messages includes the UID of the second request 308 (illustrated as having the example value of ‘1234’). Messages have sequence numbers 606 ranging from ‘1’ to ‘5’ in an arbitrary order, and only message 614 has a TRUE value in the ‘LAST’ flag field 608.

FIG. 6c is a flowchart illustrating a method of the requester 300 of FIG. 3 for identifying when the complete response set 312 has been received in accordance with a preferred embodiment of the present invention. At step 620 a next message in the response set 312 is received by the requester 300. At step 622 the requester 300 determines if a last message has been received in the response set by checking all received messages for a TRUE value in the last flag field 608. If no last message has been received the method returns to step 620. If a last message has been received, the requester 300 determines at step 624 if a complete set of messages has been received. This is determined by checking if messages with a continuous sequence of sequence numbers 606 have been received. If a complete set of messages has not been received the method returns to step 620.

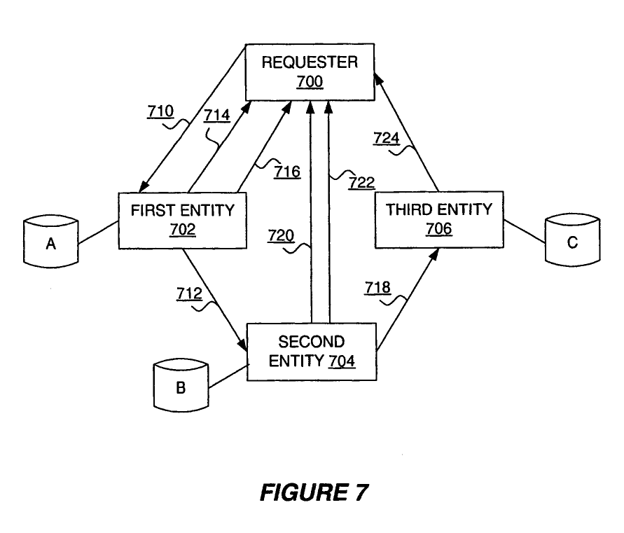

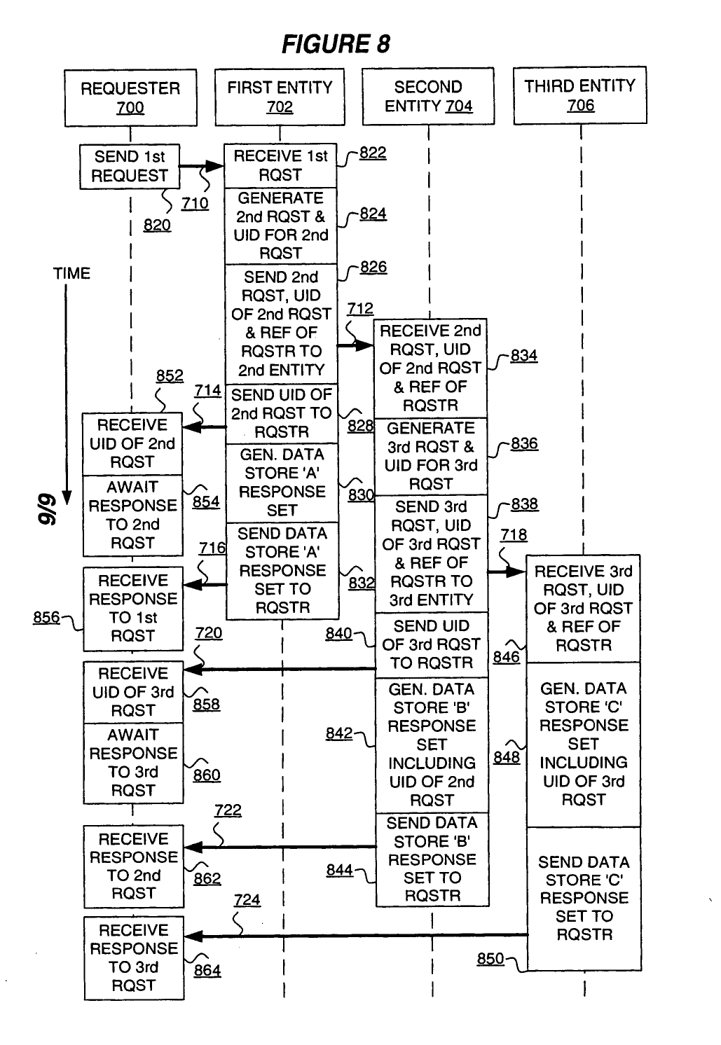

A preferred embodiment of the present invention will now be considered in use with reference to FIG. 7. FIG. 7 is a further exemplary arrangement of a network of cooperating software or hardware entities for responding to a request from a requester in accordance with a preferred embodiment of the present invention. Many of the elements of FIG. 7 are identical to those described with respect to FIG. 3 and these will not be repeated here. Only differences between FIG. 7 and FIG. 3 will be described. FIG. 7 further comprises a third entity 706 which is computer system or software component. Each of the first entity 702, second entity 704 and third entity 706 are connected to data stores ‘A’, ‘B’ and ‘C’ respectively. Only first entity 702 can access data store ‘A’, only second entity 704 can access data store ‘B’ and only third entity 706 can access data store ‘C’. The requester 700 sends a first request 710 to the first entity 702. The first request 700 is a request for data from each of the data stores ‘A’, ‘B’ and ‘C’. The details of the responses provided to the requester 700 is described below with respect to FIG. 8.

FIG. 8 is a flow diagram illustrating methods of, and data flows between, the requester 700, the first entity 702, the second entity 704 and the third entity 706 of FIG. 7 in a preferred embodiment of the present invention. At step 820 the requester 700 sends a first request 710 for data from each of the data stores ‘A’, ‘B’, and ‘C’ to the first entity 702. At step 822, the first entity 702 receives the first request and at step 824 the first entity 702 generates a second request 712 including a UID for the second request 712. At step 826 the first entity 702 sends the second request 712 including the UID for the second request 712 and a reference of the requester 700 to the second entity 704. At step 828 the first entity 702 sends a message 714 to the requester 700 including the UID of the second request 712. The message 713 including the UID of the second request 712 is received by the requester 700 at step 852, and the requester 700 accordingly awaits a response to the second request 712 from step 854. Meanwhile, at step 830 the first entity 702 generates a response set 716 including data from data store ‘A’. The response set 716 is sent to the requester 700 at step 832. At step 856 the requester 700 receives the response set 716 but continues to await the response to the outstanding second request 712.

Meanwhile, at step 834 the second entity 704 receives the second request 712 from the first entity 702 including the UID of the second request 712 and a reference to the requestor 700. At step 836 the second entity 704 generates a third request 718 including a UID for the third request 718. At step 838 the second entity 704 sends the third request 718 including the UID for the third request 718 and a reference of the requester 700 to the third entity 706. At step 840 the second entity 704 sends a message 720 to the requester 700 including the UID of the third request 718. The message 720 including the UID of the third request 718 is received by the requester 700 at step 858, and the requester 700 accordingly awaits a response to the third request 718 from step 858. Meanwhile, at step 842 the second entity 704 generates a response set 722 including data from data store ‘B’ and the UID of the second request 712. The response set 722 including the UID of the second request 712 is sent to the requester 700 at step 844. At step 862 the requester 700 receives the response set 722 including the UID of the second request 712. Additionally, the requester 700 continues to await the response to the outstanding third request 718.

Meanwhile, at step 846 the third entity 706 receives the third request 718 from the second entity 704 including the UID of the third request 718 and a reference to the requester 700. At step 848 the third entity 706 generates a response set 724 including data from data store ‘C’ and the UID of the third request 718. The response set 724 including the UID of the third request 718 is sent to the requester 700 at step 850. At step 864 the requester 700 receives the response set 724 including the UID of the third request 718. The requester 700 therefore receives a complete response set 716 from the first entity 702 including data from data store ‘A’ at step 856. The requester 700 further receives a complete response set 722 from the second entity 704 including data from data store ‘B’ at step 862. The requester 700 further receives a complete response set 724 from the third entity 706 including data from data store ‘C’ at step 864. At step 864 the requester 700 is awaiting no further response sets and is therefore able to determine that a complete response to the first request 710 has been received.

Thus, an initial request can spawn any number (zero, one or more) further requests, each of which can in turn spawn any number of yet further requests and so on to any depth, each spawning generating response set UIDs. Neither the requester nor any of the responding entities may have or needs to have any knowledge of how many requests to entities each original request might generate.

1. A method for identifying a complete response to a first request from a requesting entity, the method comprising the steps of:
the requesting entity sending the first request to a first receiving entity;
the first receiving entity sending a second request to a second receiving entity, the second request including a unique request identifier;
the first receiving entity sending the unique request identifier to the requesting entity; and
the second receiving entity sending a response to the requesting entity, the response including the unique request identifier.

2. The method of claim 1 wherein each of the requesting entity, the first receiving entity and the second receiving entity is a separate computer system.

3. The method of claim 1 wherein each of the requesting entity, the first receiving entity and the second receiving entity is a separate software component.

4. The method of claim 1 further comprising the first receiving entity sending a second response to the requesting entity.

5. The method of claim 1 wherein the response comprises a plurality of one or more response messages.

6. The method of claim 5 wherein each of the plurality of one or more response messages includes a sequence number.

7. The method of claim 6 wherein one of the plurality of one or more response messages includes a indicator that said one of the plurality of one or more response messages is a last response message.

8. The method of claim 1 further comprising the first receiving entity sending an identifier of the second receiving entity to the requesting entity.

9. The method of claim 1 further comprising the first receiving entity sending a reference to the requesting entity to the second receiving entity.

10. A system for identifying a complete response to a first request from a requesting entity, the system comprising:
means for the requesting entity to send the first request to a first receiving entity;
means for the first receiving entity to send a second request to a second receiving entity, the second request including a unique request identifier;
means for the first receiving entity to send the unique request identifier to the requesting entity; and
means for the second receiving entity to send a response to the requesting entity, the response including the unique request identifier.

11. The system of claim 10 wherein each of the requesting entity, the first receiving entity and the second receiving entity is a separate computer system.

12. The system of claim 10 wherein each of the requesting entity, the first receiving entity and the second receiving entity is a separate software component.

13. The system of claim 10 further comprising means for the first receiving entity to send a second response to the requesting entity.

14. The system of claim 10 wherein the response comprises a plurality of one or more response messages.

15. The system of claim 14 wherein each of the plurality of one or more response messages includes a sequence number.

16. The system of claim 15 wherein one of the plurality of one or more response messages includes a indicator that said one of the plurality of one or more response messages is a last response message.

17. The system of claim 10 further comprising means for the first receiving entity to send an identifier of the second receiving entity to the requesting entity.

18. The system of claim 10 further comprising means for the first receiving entity to send a reference to the requesting entity to the second receiving entity.

19. A computer program product comprising computer program code stored on a computer readable storage medium which, when executed on a data processing system, instructs the data processing system to carry out the method as claimed in and of claims 1-9.
